(19) United States
(12) Patent Application Publication
(10) Pub. No.: US 2013/0207981 A1
(43) Pub. Date: Aug. 15, 2013

(54) APPARATUS AND METHODS FOR CURSOR ANIMATION

(71) Applicant: Robert J. Quirk, Peoria, AZ (US)

(72) Inventor: Robert J. Quirk, Peoria, AZ (US)

(73) Assignee: HONEYWELL INTERNATIONAL INC., Morristown, NJ (US)

(21) Appl. No.: 13/369,788

(22) Filed: Feb. 9, 2012

(51) Int. Cl. G06T 13/00

(52) U.S. Cl. 345/473

(57) ABSTRACT

Methods and systems are provided for animating a cursor image. In an exemplary embodiment, image data for the cursor image maintained by a first memory is provided for display on a display device, and that image data is written to a second memory while being provided from the first memory for display. Prior to writing new image data for a portion of the cursor image to the first memory, the image data maintained by the second memory is provided for display on the display device and the new image data is written to the first memory while the image data maintained by the second memory is being provided to the display.

### TECHNICAL FIELD

The subject matter described herein relates generally to display systems, and more particularly, embodiments of the subject matter relate to cursor animation.

### BACKGROUND

Cursors are graphic elements that are frequently used to allow a user to correlate an input device (e.g., a mouse, pointer, or the like) with an electronic display. In practice, due to the video refresh rates and the cursor resolution, providing a cursor can require an undesirably large amount of computing resources, particularly when the cursor is being animated. For example, to animate cursors in some display systems, a new cursor image is written to a first memory while the previous cursor image is displayed, and a successive cursor image is written to a second memory while the cursor image is displayed from the first memory (e.g., ping-pong buffering). Thus, to animate the cursor, each cursor image is written in its entirety to memory and then swapped during each vertical blanking period with another memory for display. This requires the processor animating the cursor to handle an interrupt each vertical blanking period and allocate sufficient computing resources, particularly as the resolution of the cursor increases, to ensure each cursor image can be written within the frame period and animated properly (e.g., without incomplete and/or fragmented cursor images).

### BRIEF SUMMARY

In one exemplary embodiment, a device is provided that includes an image data input for receiving new image data, an image data output, a first memory having a first write data input coupled to the image data input and a first read data output, a second memory having a second write data input coupled to the first read data output and a second read data output, and image selection logic coupled to the first read data output, the second read data output, and the image data output. The device also includes image update logic coupled to the image selection logic, wherein the image update logic is configured to operate the image selection logic to provide image data from the first read data output to the image data output and operate the image selection logic to provide the image data from the second read data output to the image data output prior to the new image data being written to the first memory.

In another embodiment, a method of animating a cursor image is provided. The method involves providing image data for the cursor image maintained by a first memory for display on a display device, writing the image data to a second memory while providing the image data maintained by the first memory for display on the display device, and prior to writing new image data for a portion of the cursor image to the first memory: providing the image data maintained by the second memory for display on the display device and writing the new image data to the first memory while providing the image data maintained by the second memory.

In yet another embodiment, a display system is provided that includes a display device, a cursor image logic device coupled to the display device, and a processing module coupled to the cursor image logic device. The cursor image logic device includes a first memory and a second memory, and the cursor image logic device is configured to provide image data for a cursor image from the first memory to the display device and write the image data from the first memory to the second memory concurrently to providing the image data from the first memory to the display device. The processing module is configured to provide a cursor update signal, wherein the cursor image logic device is configured to provide the image data from the second memory to the display device in response to the cursor update signal.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the subject matter will hereinafter be described in conjunction with the following drawing figures, wherein like numerals denote like elements, and:

FIG. 1 is a block diagram of a display system in an exemplary embodiment;

FIG. 2 is a schematic view of an exemplary cursor image logic device suitable for use in the display system of FIG. 1 in accordance with one or more embodiments;

FIG. 3 is a flow diagram of an exemplary cursor animation process suitable for use with the display system of FIG. 1 in accordance with one or more embodiments; and

FIGS. 4-6 depict a sequence of cursor images that may be presented on a display device in the display system of FIG. 1 in connection with the cursor animation process of FIG. 3 in accordance with one or more embodiment.

### DETAILED DESCRIPTION

The following detailed description is merely exemplary in nature and is not intended to limit the subject matter of the application and uses thereof. Furthermore, there is no intention to be bound by any theory presented in the preceding background, brief summary, or the following detailed description.

Embodiments of the subject matter described herein relate to efficiently animating cursor images. As described in greater detail below, in exemplary embodiments, the cursor image is written to a primary memory (or back buffer), and when the cursor image is not being animated or changed, the cursor image maintained by the primary memory is provided for rendering and/or presentation on the display device. While the cursor image maintained by the primary memory is provided to the display device, the cursor image is copied or otherwise written to a secondary memory (or front buffer). To animate the cursor image, the cursor image maintained by the secondary memory is provided to the display device substantially immediately (e.g., on display of the next pixel of the cursor image) for the remaining pixels of the cursor image, thereby allowing the cursor image data maintained by the primary memory to be updated or modified within the current image (or video) frame without fragmenting or otherwise interfering with the displayed cursor image by virtue of the cursor image maintained by the secondary memory being identical to the cursor image maintained by the primary memory. Once the secondary memory is providing the displayed cursor image, the cursor image maintained by the primary memory is updated by writing new cursor image data to the primary memory. In this regard, only the portion of the cursor image to be animated or modified needs to be written to the primary memory, while the remaining cursor image data in the primary memory remains unchanged. The new cursor image data may be written to the primary memory asynchronously the display of the cursor image from the secondary memory (i.e., the write clock signal for the primary memory and the read clock signal for the secondary memory are not synchronous). After the new cursor image data is written to the primary memory, the updated cursor image maintained by the primary memory is provided to the display device on the next image frame. Once the updated cursor image maintained by the primary memory is being provided to the display device, the updated cursor image is again copied or otherwise written to the secondary memory.

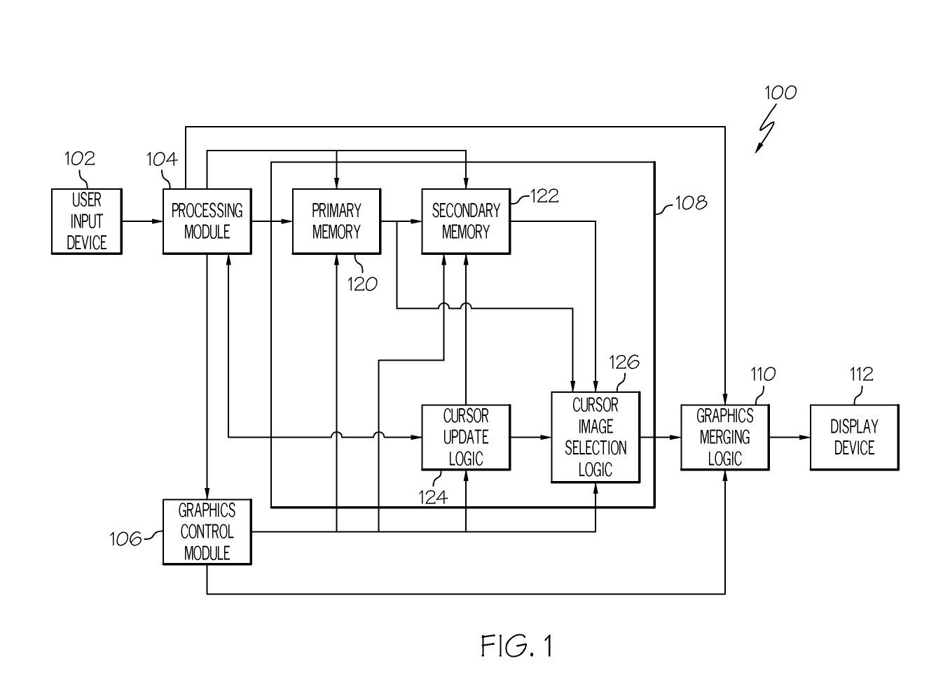

FIG. 1 depicts an exemplary embodiment of a display system 100 which may be utilized with a vehicle, such as an aircraft. In an exemplary embodiment, the display system 100 includes, without limitation, a user input device 102, a processing module 104, a graphics control module 106, a cursor image logic device 108, graphics merging logic 110, and a display device 112. It should be understood that FIG. 1 is a simplified representation of the display system 100 for purposes of explanation and ease of description, and FIG. 1 is not intended to limit the application or scope of the subject matter described herein in any way. In this regard, although FIG. 1 depicts the cursor image logic device 108 as a discrete device, in practice, the cursor image logic device 108 may be integrated with the processing module 104 and/or the graphics control module 106.

In the illustrated embodiment, the user input device 102 is coupled to the processing module 104 to allow a user to interact with the display device 112 and/or other elements of the display system 100. Depending on the embodiment, the user input device 102 may be realized as a keypad, touchpad, keyboard, mouse, touch panel (or touchscreen), joystick, knob, line select key or another suitable device adapted to receive input from a user. The processing module 104 generally represents the hardware, firmware and/or other components of the display system 100 which are configured to interact with the user input device 102 and other external elements and/or systems, generate graphics data for display on the display device 112, provide a graphical cursor associated with the user input device 102 overlying the graphics displayed on the display device 112, and perform additional tasks and/or functions to support operation of the display system 100, as described in greater detail below. Depending on the embodiment, the processing module 104 may be implemented or realized with a general purpose processor, a controller, a microprocessor, a microcontroller, a content addressable memory, a digital signal processor, an application specific integrated circuit, a field programmable gate array, any suitable programmable logic device, discrete gate or transistor logic, processing core, discrete hardware components, or any combination thereof, designed to perform the functions described herein. In practice, the processing module 104 includes processing logic that may be configured to carry out the functions, techniques, and processing tasks associated with the operation of the display system 100 described in greater detail below. Furthermore, the steps of a method or algorithm described in connection with the embodiments disclosed herein may be embodied directly in hardware, in firmware, in a software module executed by the processing module 104, or in any practical combination thereof. In accordance with one or more embodiments, the processing module 104 includes or otherwise accesses a memory or another suitable non-transitory short or long term storage media capable of storing computer-executable programming instructions or other data for execution that, when read and executed by the processing module 104, cause the processing module 104 to execute and perform one or more of the processes tasks, operations, and/or functions described herein.

The graphics control module 106 generally represents the hardware, firmware and/or other components of the display system 100 which are configured to receive graphics data from the processing module 104 (or applications being executed by the processing module 104), process and/or buffer the graphics data, provide image (or video) frames corresponding to the graphics data provided by the processing module 104 to the display device 112, and perform additional tasks and/or functions to support operation of the display system 100, as described in greater detail below. In this regard, the graphics control module 106 may be implemented or otherwise realized as a graphics processor or graphics processing unit (GPU). In practice, as described above in the context of the processing module 104, the graphics control module 106 may also include processing logic configured to carry out functions and/or processing tasks associated with the operation of the display system 100 described in greater detail below, and the graphics control module 106 may include or otherwise access a memory or another suitable non-transitory short or long term storage media capable of storing computer-executable programming instructions or other data for execution that, when read and executed by the graphics control module 106, cause the graphics control module 106 to execute and perform one or more of the processes tasks, operations, and/or functions described herein.

In exemplary embodiments, the display device 112 is realized as an electronic display device capable of graphically displaying image (or video) frames provided by the graphics control module 106, such as, for example, a liquid crystal display (LCD), a light emitting diode (LED) display, an organic light emitting diode (OLED) display, a plasma display, or another suitable electronic display. The graphics merging logic 110 generally represents the hardware, firmware, and/or other components coupled between the display device 112 and the outputs of the cursor image logic device 108 and the graphics control module 106 that is configured to merge or otherwise combine the cursor image data provided by the cursor image logic device 108 with the image frames provided by the graphics control module 106 to provide a displayed cursor image overlying a displayed image frame at a location on the display device 112 such that the displayed cursor image corresponds to a relative location of the user input device 102. For example, the processing module 104 may obtain the physical location of the user input device 102, correlate the physical location of the user input device 102 to a location for the cursor image on the display device 112, and provide the cursor image location to the graphics merging logic 110 for rendering the cursor image provided by the cursor image logic device 108 at the appropriate location on the display device 112.

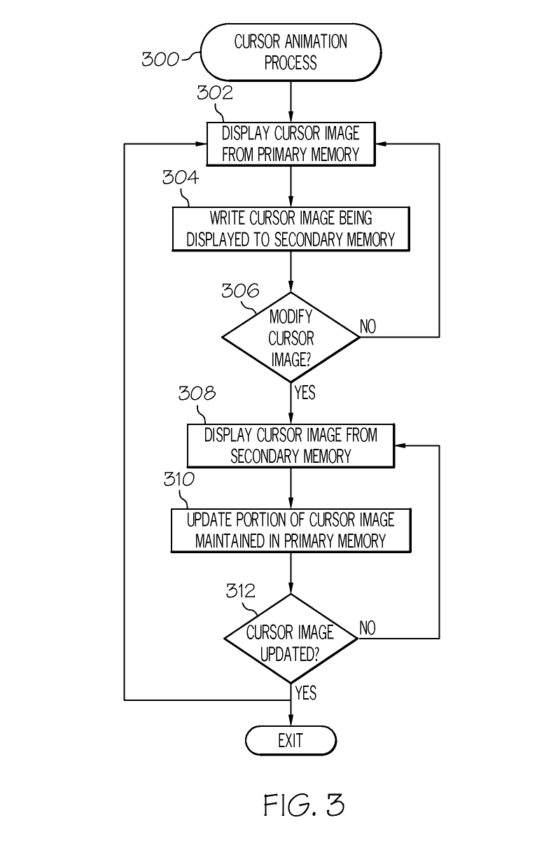

In an exemplary embodiment, the cursor image logic device 108 is coupled to the processing module 104 and receives data and/or information for cursor images to be presented on the display device 112 along with other commands, instructions and/or signals for writing the cursor image data to the cursor image logic device 108, as described in greater detail below in the context of the cursor animation process 300 of FIG. 3. In an exemplary embodiment, the cursor image logic device 108 includes a first memory 120 for receiving cursor image data from the processing module 104 and a second memory 122 for copying cursor image data from the first memory 120. For convenience and ease of explanation, but without limitation, the first memory 120 may alternatively be referred to herein as the primary memory (or back buffer) and the second memory 122 may alternatively be referred to herein as the secondary memory (or front buffer). In exemplary embodiments, the memories 120, 122 are realized as dual port memories capable of being written to and/or read from concurrently. As illustrated, the cursor image logic device 108 also includes cursor update logic 124 and image selection logic 126 configured to control which of the memories 120, 122 provides cursor image data to the display device 112. As described in greater detail below in the context of FIG. 3, the cursor update logic 124 is coupled to the processing module 104, and the cursor update logic 124 is configured to operate the image selection logic 126 so that the cursor image data read from the primary memory 120 is provided to the display device 112 until receiving a cursor update signal from the processing module 104. While the cursor image data read from the primary memory 120 is being provided to the display device 112, the cursor update logic 124 provides a write signal to the input port of the secondary memory 122 so that the cursor image data read from the primary memory 120 is written to the secondary memory 122. In response to receiving the cursor update signal from the processing module 104, the cursor update logic 124 removes the write signal at the input port of the secondary memory 122 to stop writing cursor image data to the secondary memory 122 and operates the image selection logic 126 so that cursor image data read from the secondary memory 122 is provided to the display device 112 while at least a portion of the cursor image data in the primary memory 120 is being updated and/or rewritten, as described in greater detail below in the context of FIG. 3.

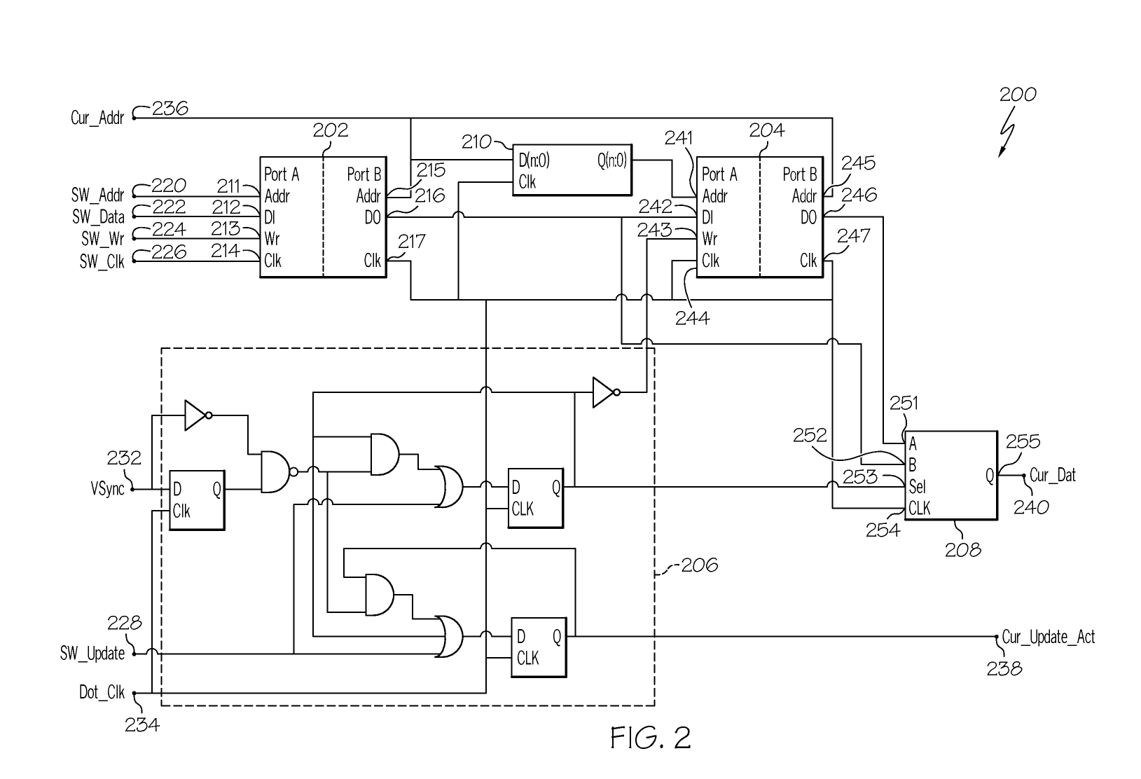

FIG. 2 depicts an exemplary embodiment of a cursor image logic device 200 suitable for use as the cursor image logic device 108 in the display system 100 of FIG. 1. The cursor image logic device 200 includes, without limitation, a first dual-port memory 202 (e.g., primary memory 120), a second dual-port memory 204 (e.g., secondary memory 122), cursor update logic 206 (e.g., cursor update logic 124), cursor image selection logic 208 (e.g., image selection logic 126), and a delay element 210. It should be understood that FIG. 2 is a simplified representation of the cursor image logic device 200 for purposes of explanation and ease of description, and FIG. 2 is not intended to limit the application or scope of the subject matter described herein in any way. Thus, although FIG. 2 depicts direct electrical connections between circuit elements and/or terminals, alternative embodiments may employ intervening circuit elements and/or components while functioning in a substantially similar manner.

In the illustrated embodiment, the cursor image logic device 200 includes a cursor write address input 220 that is coupled to a processing module (e.g., processing module 104) and configured to receive a location or address (e.g., a particular pixel location) within the cursor image that is to be updated and/or rewritten. For example, for 128 pixel by 128 pixel cursor image, the cursor image write address (e.g., SW_Addr) at the cursor write address input 220 corresponds to one of the 16,384 pixel locations within the cursor image. The cursor image logic device 200 also includes an image data input 222 that is coupled to the processing module and configured to receive the new and/or updated image data (e.g., SW_Data) that is to be written to the location indicated by the cursor image write address at the cursor write address input 220. The cursor image logic device 200 also includes a cursor write input 224 that is coupled to the processing module and configured to receive a write command (or signal) (e.g., SW_Wr) and a cursor write clock input 226 that is coupled to the processing module and configured to receive clock signal for writing the new cursor image data. The write data port (e.g., Port A) of the primary memory 202 includes a write address input 211 coupled to the cursor write address input 220, a write data input 212 coupled to the image data input 222, a write input 213 coupled to the cursor write input 224, and a write clock input 214 coupled to the cursor write clock input 226. In this regard, while the write command is applied (e.g., a logical high signal) at the cursor write input 224, a rising edge of the write clock signal at the cursor write clock input 226 causes the primary memory 202 to write or otherwise update the cursor image data at the cursor image write address (e.g., SW_Addr) in the primary memory 202 with the new cursor image data (e.g., SW_Data) at the image data input 222. The read data port (e.g., Port B) of the primary memory 202 includes a read address input 215, a read data output 216, and a read clock input 217. The read address input 215 is coupled to a cursor read address input 236 of the cursor image logic device 200 configured to receive a location or address (e.g., a particular pixel location) within the cursor image that is to be rendered and/or presented on a display (e.g., display device 112). The read clock input 217 is coupled to a display clock input 234 of the cursor image logic device 200 to receive a display clock signal (e.g., Dot_Clk) which is synchronous with a clock signal of the display device. In this regard, a graphics control module (e.g., graphics control module 106) may be coupled to the display clock input 234 to provide a display clock signal synchronous with a display device (e.g., display device 112) and the cursor read address input 236 to provide the location of the cursor image to be rendered and/or presented on the display device. A rising edge of the display clock signal at the read clock input 217 causes the primary memory 202 to read or otherwise access the cursor image data at the cursor image read address (e.g., Cur_Addr) in the primary memory 202 and output the stored cursor image data at the read data output 216.

Still referring to FIG. 2, the write data port of the secondary memory 204 includes a write address input 241, a write data input 242, a write input 243, and a write clock input 244. The write address input 241 is coupled to the cursor read address input 236 via the delay element 210. In this regard, the delay element 210 is realized as a register or the like having an input coupled to the cursor read address input 236, an output coupled to the write address input 241, and a clock input coupled to the display clock input 234 so that the cursor image write address provided at the write address input 241 corresponds to the cursor image read address from the previous cycle of the display clock signal. The write data input 242 is coupled to the read data output 216 of the primary memory 202, the write clock input 244 is coupled to the display clock input 234, and the write input 243 is coupled to the cursor update logic 206. As described in greater detail below, in the absence of a cursor update signal (e.g., SW_Update), the cursor update logic 206 applies a logical high signal (or write command) to the write input 243, such that a rising edge of the display clock signal at the display clock input 234 causes the secondary memory 204 to write or otherwise update the cursor image data at the cursor read address from the preceding display clock cycle in the secondary memory 204 with the cursor image data that was read from that address in the primary memory 202 during the preceding display clock cycle. In this regard, the secondary memory 204 effectively copies the primary memory 202 as cursor image data is read from or otherwise output by the primary memory 202. The read data port of the secondary memory 204 includes a read address input 245, a read data output 246, and a read clock input 247. The read address input 245 is coupled to the cursor read address input 236 and the read clock input 217 is coupled to the display clock input 234, such that a rising edge of the display clock signal at the read clock input 217 causes the secondary memory 204 to read or otherwise access the cursor image data at the cursor image read address (e.g., Cur_Addr) in the secondary memory 204 and output the stored cursor image data at the read data output 246.

In an exemplary embodiment, the cursor image selection logic 208 is realized as a multiplexer having a first data input 251 coupled to the read data output 216, a second data input 252 coupled to the read data output 246, a selection input 253 coupled to the cursor update logic 206, a clock input 254 coupled to the display clock input 234, and a data output 255 coupled to a cursor image data output 240 of the cursor image logic device 200. The cursor update logic 206 is coupled to a cursor update input 228 of the cursor image logic device 200, which, in turn, is coupled to the processing module (e.g., processing module 104) to receive a cursor update signal or command (e.g., SW_Update) indicative of a desire to animate or otherwise modify at least a portion of the cursor image. The cursor update logic 206 is also coupled to a frame synchronization input 232 of the cursor image logic device 200 which is configured to receive a signal indicative of a new frame being presented on the display (e.g., a vertical blanking signal). In the absence of the cursor update signal at the cursor update input 228 (e.g., a logical low signal at the cursor update input 228), the cursor update logic 206 provides a first selection signal at the selection input 253 that causes the cursor image selection logic 208 to provide the cursor image data at the cursor image read address (e.g., Cur_Addr) in the primary memory 202 to the data output 255 and/or cursor image data output 240 on each rising edge of the display clock signal. In response to the cursor update signal being asserted, on the next rising edge of the display clock signal, the cursor update logic 206 provides a second selection signal at the selection input 253 that causes the cursor image selection logic 208 to provide the cursor image data at the cursor image read address (e.g., Cur_Addr) in the secondary memory 204 to the data output 255 and/or cursor image data output 240 on the next rising edge of the display clock signal. In this regard, the cursor image data from the secondary memory 204 is provided to the data output 255 and/or cursor image data output 240 display device for the next pixel of the cursor image. Additionally, in response to the cursor update signal being asserted, the cursor update logic 206 removes the write signal at the write input 243 (e.g., by providing a logical low signal to the write input 243) on the next rising edge of the display clock signal to cause the secondary memory 204 to stop writing cursor image data from primary memory 202 to the secondary memory 204. After the cursor update signal is removed from the cursor update input 228, on the next falling edge of the vertical blanking signal, the cursor update logic 206 reasserts the write signal at the write input 243 and provides a selection signal at the selection input 253 that causes the image selection logic 208 to resume providing the cursor image data at the cursor image read address in the primary memory 202 to the data output 255 and/or cursor image data output 240. Thus, the updated cursor image in the primary memory 202 will be provided to the display device for the next frame displayed on the display device.

Still referring to FIG. 2, the cursor update logic 206 also generates an active update signal (e.g., Cur_Update_Act) at a cursor update acknowledgement output 238 of the cursor image logic device 200 on the next rising edge of the display clock signal after the cursor update signal is asserted. In an exemplary embodiment, the cursor update logic 206 maintains the active update signal at the cursor update acknowledgement output 238 in an asserted state until the next falling edge of the vertical blanking signal at frame synchronization input 232 after the cursor update signal is removed or deasserted. In this regard, the asserted (e.g., logical high) active update signal also indicates that the secondary memory 204 does not reflect the updated cursor image data written to the primary memory 202 while a deasserted active update signal indicates that the secondary memory 204 reflects or is otherwise identical to the cursor image data written to the primary memory 202. In exemplary embodiments, the processing module (e.g., processing module 104) is coupled to the cursor update acknowledgement output 238 and verifies that the active update signal is deasserted or otherwise removed (e.g., logical low) prior to updating the cursor image data in the primary memory 202 (e.g., prior to asserting the cursor update signal) to ensure that the secondary memory 204 reflects any previously updated cursor images prior to modifying the cursor image data maintained by the primary memory 202. In some embodiments, the active update signal may be utilized by the processing module prior to modifying the cursor image data in the primary memory 202 as an indication that the cursor image data from the secondary memory 204 is being provided to the cursor image data output 240 and that the primary memory 202 may be written to without interfering with the displayed cursor image.

Turning now to FIG. 3, in an exemplary embodiment, a cursor animation process 300 is implemented or otherwise performed by a display system to efficiently animate or otherwise modify a cursor image. For illustrative purposes, the following description of FIG. 3 refers to elements mentioned above in connection with FIGS. 1-2. In practice, portions of the cursor animation process 300 may be performed by different elements of the display system 100, such as, for example, the processing module 104, the graphics control module 105, the cursor image logic device 108, 200, the primary memory 120, 202, the secondary memory 122, 204, the cursor update logic 124, 206, the image selection logic 126, 208, the graphics merging logic 110 and/or the display device 112. It should be appreciated that the cursor animation process 300 may include any number of additional or alternative tasks, the tasks need not be performed in the illustrated order and/or the tasks may be performed concurrently, and/or the cursor animation process 300 may be incorporated into a more comprehensive procedure or process having additional functionality not described in detail herein. Moreover, one or more of the tasks shown and described in the context of FIG. 3 could be omitted from a practical embodiment of the cursor animation process 300 as long as the intended overall functionality remains intact.

Referring to FIG. 3, and with continued reference to FIGS. 1-2, in an exemplary embodiment, the cursor animation process 300 begins by displaying the cursor image maintained by the primary memory (or back buffer) and writing or otherwise copying the displayed cursor image data to the secondary memory (or front buffer) until identifying that the cursor image should be animated, modified, or otherwise updated (tasks 302, 304, 306). In this regard, in the absence of a need to modify or otherwise animate the cursor image (e.g., a logical low cursor update signal at the cursor update input 228), the cursor update logic 124, 206 operates the image selection logic 126, 208 to provide cursor image data from the primary memory 202 to the cursor image data output 240 and asserts or otherwise provides a write signal to the write input 243 to cause the secondary memory 122, 204 to write the cursor image data provided by the primary memory 202 to the corresponding address in the secondary memory 122, 204. Thus, the secondary memory 122, 204 continuously writes or otherwise copies cursor image data from the primary memory 120, 202 so that the contents of the secondary memory 122, 204 are substantially the same as the primary memory 120, 202 after the entirety of the cursor image stored in the primary memory 120, 202 is displayed on the display device 112. During rendering of a frame from the graphics control module 106 on the display device 112, when the graphics merging logic 110 reaches a location within the frame where the cursor image should be displayed, the respective location of the cursor image to be displayed at that location of the frame is provided as the cursor image read address (e.g., Cur_Addr) at the cursor read address input 236 (e.g., by the processing module 104, the graphics control module 106, the graphics merging logic 110, or other cursor display logic that tracks the pixel of the cursor image to be rendered on the display device 112) and the graphics merging logic 110 overlays or otherwise merges the cursor image data from the primary memory 202 at the cursor image data output 240 with the frame graphics to display the cursor image at the appropriate location on the display device 112.

In response to identifying that the cursor image should be animated, modified, or otherwise updated, the cursor animation process 300 continues by displaying the cursor image maintained by the secondary memory (or front buffer) and writing new cursor image data to the primary memory (or back buffer) to update at least a portion of the cursor image data maintained by the primary memory (tasks 308, 310). When the processing module 104 determines or otherwise identifies that the cursor image should be animated or otherwise modified (e.g., in response to the user input device 102 being moved from a stationary position), the processing module 104 asserts or otherwise provides a cursor update signal (or command) to the cursor update input 228 of the cursor image logic device 108, 200. In response to the cursor update signal being asserted, on the next rising edge of the display clock signal, the cursor update logic 124, 206 operates the cursor image selection logic 126, 208 to provide cursor image data at the cursor image read address (e.g., Cur_Addr) in the secondary memory 122, 204 to the cursor image data output 240 and temporarily stops writing cursor image data to the secondary memory 122, 204. After operating the cursor image selection logic 126, 208 to provide cursor image data from secondary memory 122, 204 to the display device 112, the cursor update logic 124, 206 generates, asserts, or otherwise provides an active update signal (e.g., a logical high signal at the cursor update acknowledgement output 238.

After providing the cursor update signal, the processing module 104 modifies the cursor image data maintained by the primary memory 120, 202 by providing the addresses for the portions of the cursor image data to be modified to the cursor write address input 220 of the cursor image logic device 108, 200 along with the corresponding new cursor image data to be written over the previous cursor image data at those addresses at the new cursor image data input 222 while asserting the write signal at the cursor write input 224 and clocking the primary memory 120, 202 in the appropriate manner. In this regard, the processing module 104 writes the new cursor image data to the primary memory 120, 202 asynchronously to the display clock signal, thereby avoiding the need to perform clock-crossing synchronization which may increase the amount of time required to write the new cursor image data. To animate the cursor, the processing module 104 modifies the portions of the cursor image maintained by the primary memory 120, 202 that are to be animated (e.g., by writing new cursor image data to the subset of the addresses in the primary memory 120, 202 corresponding to the portion of the cursor image to be animated) while the remaining cursor image data maintained by the primary memory 120, 202 is not overwritten and remains unchanged. Thus, to animate the cursor image, the entire cursor image does not need to be completely rewritten to the primary memory 120, 202 when only a portion of the cursor image is being animated and/or modified. Accordingly, the processing module 104 the updated cursor image data may be written to the primary memory 120, 202 in a reduced number of clock cycles (e.g., cycles of the processor clock signal at the write clock input 226), thereby conserving resources of the processing module 104 when animating the cursor image. In an exemplary embodiment, the cursor animation process 300 continues displaying the cursor image data maintained by the secondary memory and writing new cursor image data to the primary memory until the portion of the cursor image to be modified or animated has been completely written to the primary memory (tasks 308, 310, 312).

Once the new cursor image data has been written to the primary memory, the cursor animation process 300 resumes displaying the cursor image maintained by the primary memory (or back buffer) and writing or otherwise copying the displayed cursor image data to the secondary memory (or front buffer) (tasks 302, 304, 312). In this regard, after the processing module 104 has completed writing the new cursor image data to the desired addresses in the primary memory 120, 202, the processing module 104 removes the cursor update signal (e.g., by providing a logical low signal at the cursor update input 228) and the cursor write signal at the cursor write input 224. On the next vertical blanking signal after the cursor update signal is removed, the cursor update logic 124, 206 operates the cursor image selection logic 126, 208 to provide cursor image data from the primary memory 120, 202 to the cursor image data output 240 and resumes writing cursor image data to the secondary memory 122, 204. In this regard, after the cursor update signal is removed, the cursor image data is still provided by the secondary memory 122, 204 until the next frame is rendered and/or displayed, thereby ensuring the cursor animation is synchronous with the change in displayed image frames and avoiding any discontinuities or other undesirable visual artifacts in the cursor image within the current frame that may otherwise result from switching from the secondary memory 122, 204 back to the primary memory 120, 202. During the next frame, the updated cursor image data maintained by the primary memory 120, 202 is displayed on the display device 112, thereby animating the cursor image on the display device 112 with respect to the previously displayed cursor image, and at the same time, the updated cursor image data is concurrently written or otherwise copied to the secondary memory. As described above, after the next vertical blanking signal, the active update signal is deasserted, thereby indicating to the processing module 104 that the secondary memory 122, 204 is up-to-date and that the processing module 104 may update or otherwise modify the cursor image data in the primary memory 120, 202.

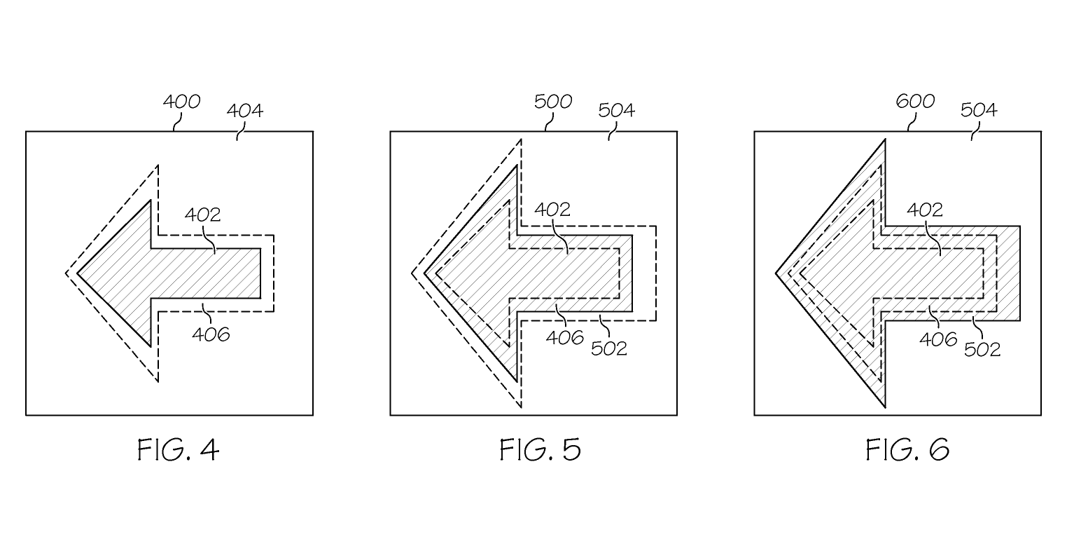

FIGS. 4-6 illustrate an exemplary sequence of cursor images that may be presented on the display device 112 in connection with an exemplary embodiment of the cursor animation process 300 of FIG. 3. In this regard, FIGS. 4-6 represent the cursor image data that is maintained by the primary memory 120, 202. For example, in accordance with one embodiment, when the user input device 102 is moved after having been stationary for a sufficient amount of time, the processing module 104 may animate the cursor image corresponding to the user input device 102 so that the user may more easily identify the cursor image on the display device 112. In this regard, FIG. 4 depicts the initial cursor image data 400 maintained by the primary memory 120, 202 and rendered on the display device 112 while the user input device 102 is stationary. When the location of the user input device 102 changes after being stationary for a sufficient amount of time, the processing module 104 identifies that the cursor image should be animated and provides a cursor update signal to the cursor image logic device 108, 200. In response to the cursor update signal being asserted, the cursor update logic 124, 206 operates the cursor image selection logic 126, 208 to provide initial cursor image data 400 from the secondary memory 122, 204 to the display device 112 via the graphics merging logic 110.

Referring to FIGS. 4-5, as described above, the processing module 104 modifies the cursor image data 400 maintained by the primary memory 120, 202 by providing the addresses for the portion 406 of the cursor image data 400 to be modified to the cursor write address input 220 of the cursor image logic device 108, 200 along with the corresponding new cursor image data to be written over that portion 406 of the previous cursor image data 400 while asserting the write signal at the cursor write input 224 and clocking the primary memory 120, 202 in the appropriate manner, resulting in the updated cursor image data 500 being written to the primary memory 120, 202. In this regard, the processing module 104 only modifies the portion 406 of the cursor image data 400 maintained by the primary memory 120, 202 that is to be animated while the remaining portions 402, 404 of the cursor image data 400 are not overwritten and remain unchanged to obtain the updated cursor image data 500. Once the processing module 104 completes writing the animated portion 406 of the cursor image to the primary memory 120, 202, after the next vertical blanking signal, the cursor image logic device 108, 200 provides the updated cursor image data 500 from the primary memory 120, 202 to the display device 112 and writes the updated cursor image data 500 to the secondary memory 122, 204.

Turning now to FIGS. 5-6, after the active update signal is deasserted, to continue animation of the cursor image, the processing module 104 modifies the portion 502 of the cursor image data 500 maintained by the primary memory 120, 202 that is to be animated while the remaining portions 402, 406, 504 of the cursor image data 500 are not overwritten and remain unchanged to obtain the updated cursor image data 600. Once the processing module 104 completes writing the animated portion 502 of the cursor image to the primary memory 120, 202, after the next vertical blanking signal, the cursor image logic device 108, 200 provides the updated cursor image data 600 from the primary memory 120, 202 to the display device 112 and writes the updated cursor image data 600 to the secondary memory 122, 204

To briefly summarize, one advantage of the systems and methods described herein is that only the changes to successive cursor images need to be written to memory, rather than writing the entire updated cursor image to memory. Additionally, the new cursor image data be written to the primary memory during the same image (or video) frame without fragmenting or otherwise interfering with the displayed cursor image by utilizing the secondary memory to provide the remaining displayed pixels of the cursor image. Once the primary memory is updated, the updated cursor image is displayed on the next frame and copied to the secondary memory, thereby ensuring the secondary memory maintains an updated copy of the cursor image maintained by the primary memory.

For the sake of brevity, conventional techniques related to graphics and image processing, rasterization and/or raster graphics, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or devices. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. Furthermore, embodiments of the subject matter described herein can be stored on, encoded on, or otherwise embodied by any suitable non-transitory computer-readable medium as computer-executable instructions or data stored thereon that, when executed (e.g., by processing module 104), facilitate identifying optimal taxi routes and displaying completed taxi clearances on a display device (e.g., display device 112) in accordance with the processes described above.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements, additional intervening elements, devices, features, or components may be present in an embodiment of the depicted subject matter. In addition, certain terminology may also be used in the following description for the purpose of reference only, and thus are not intended to be limiting.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It being understood that various changes may be made in the function and arrangement of elements described in an exemplary embodiment without departing from the scope of the subject matter as set forth in the appended claims.

What is claimed is:

1. A device comprising:
a image data input for receiving new image data;
a image data output;
a first memory having a first write data input and a first read data output, the first write data input being coupled to the image data input;
a second memory having a second write data input and a second read data output, the second write data input being coupled to the first read data output;
image selection logic coupled to the first read data output, the second read data output, and the image data output; and
image update logic coupled to the image selection logic, the image update logic being configured to:
operate the image selection logic to provide image data from the first read data output to the image data output;
operate the image selection logic to provide the image data from the second read data output to the image data output prior to the new image data being written to the first memory.

2. The device of claim 1, wherein the image update logic is configured to operate the second memory to write the image data from the first read data output to the second memory prior to operating the image selection logic to provide the image data from the second read data output to the image data output.

3. The device of claim 1, further comprising an update input for receiving an image update signal, wherein the image update logic is coupled to the update input and configured to automatically operate the image selection logic to provide the image data from the second read data output to the image data output in response to assertion of the image update signal.

4. The device of claim 3, further comprising a synchronization input for receiving a frame synchronization signal, the image update logic being coupled to the synchronization input, wherein after operating the image selection logic to provide the image data from the second read data output to the image data output, the image update logic is configured to operate the image selection logic to provide the new image data from the first read data output to the image data output in response to receiving the frame synchronization signal after deassertion of the image update signal.

5. The device of claim 4, wherein the image update logic is configured to operate the second memory to write the new image data from the first read data output to the second memory while operating the image selection logic to provide the new image data from the first read data output to the image data output.

6. The device of claim 1, wherein the first memory is configured to write the new image data asynchronously to the second memory providing the image data from the second read data output to the image data output.

7. The device of claim 1, wherein the second memory is configured to write the image data at the second write data input synchronously to the first memory providing the image data from the first read data output.

8. The device of claim 7, further comprising a delay element coupled between an read address input of the first memory and a write address input of the second memory, the delay element delaying a read address at the read address input synchronously to the first memory providing the image data from the first read data output and the second memory writing the image data at the second write data input.

9. A method of animating an image, the method comprising:
providing image data for the image maintained by a first memory for display on a display device;
writing the image data to a second memory while providing the image data maintained by the first memory for display on the display device; and
prior to writing new image data for a portion of the image to the first memory:
providing the image data maintained by the second memory for display on the display device; and
writing the new image data to the first memory while providing the image data maintained by the second memory.

10. The method of claim 9, wherein:
writing the new image data results in updated image data maintained by the first memory; and
the method further comprises:
providing the updated image data for the image maintained by the first memory for display on the display device after writing the new image data to the first memory; and
writing the updated image data to the second memory while providing the updated image data for display on the display device.

11. The method of claim 10, wherein providing the updated image data for the image maintained by the first memory comprises:
receiving a frame synchronization signal after the writing the new image data; and
automatically providing the updated image data maintained by the first memory in response to the frame synchronization signal received after writing the new image data.

12. The method of claim 10, further comprising:
receiving a cursor update signal prior to writing the new image data to the first memory, the cursor update signal being removed after writing the new image data to the first memory; and
receiving a frame synchronization signal after the cursor update signal is removed, wherein:
providing the image data maintained by the second memory comprises automatically providing the image data maintained by the second memory in response to assertion of the cursor update signal; and
providing the updated image data for the image maintained by the first memory comprises automatically providing the updated image data maintained by the first memory in response to the frame synchronization signal received after the cursor update signal is removed.

13. The method of claim 9, further comprising receiving a cursor update signal, wherein providing the image data maintained by the second memory comprises automatically providing the image data maintained by the second memory in response to assertion of the cursor update signal.

14. The method of claim 9, wherein writing the new image data to the first memory while providing the image data maintained by the second memory comprises writing the new image data asynchronously to providing the image data maintained by the second memory.

15. The method of claim 14, wherein writing the image data to the second memory while providing the image data maintained by the first memory for display on the display device comprises writing the image data to the second memory synchronously to providing the image data maintained by the first memory.

16. A display system comprising:
a display device;
a cursor image logic device coupled to the display device, the cursor image logic device including a first memory and a second memory, wherein the cursor image logic device is configured to:
provide image data for a cursor image from the first memory to the display device; and
write the image data from the first memory to the second memory concurrently to providing the image data from the first memory to the display device; and
a processing module coupled to the cursor image logic device configured to provide a cursor update signal, wherein the cursor image logic device is configured to provide the image data from the second memory to the display device in response to the cursor update signal.

17. The display system of claim 16, wherein the processing module is configured to write new image data for a portion of the cursor image to the first memory after providing the cursor update signal.

18. The display system of claim 17, further comprising a graphics control module coupled to the cursor image logic device and the display device, the graphics control module providing a frame synchronization signal, wherein:
the processing module is configured to remove the cursor update signal after writing the new image data to the first memory; and
the cursor image logic device is configured to:
provide the new image data from the first memory to the display device after receiving the frame synchronization signal when the cursor update signal is removed; and
write the new image data from the first memory to the second memory concurrently to providing the new image data from the first memory to the display device.

19. The display system of claim 17, wherein the processing module is configured to write the new image data to the first memory asynchronously to the cursor image logic device providing the image data from the second memory to the display device.

20. The display system of claim 16, further comprising an input device coupled to the processing module, wherein a location of the cursor image on the display device corresponds to a position of the input device.
